(19) United States
(12) Patent Application Publication
(10) Pub. No.: US 2003/0201057 A1
(43) Pub. Date: Oct. 30, 2003

(54) Method for splicing a belt

(76) Inventors: Troy D. Dolan, Blairsville, PA (US); Joseph Gibson, Blairsville, PA (US)

Correspondence Address: The Bilicki Law Firm, P.C., Furniture Mart Building, 111 West Second Street, Suite 1000, Jamestown, NY, 14701, US

(21) Appl. No.: 10/454,358

(22) Filed: Jun. 3, 2003

Related U.S. Application Data
(63) Continuation-in-part of application No. 09/809,601, filed on Mar. 15, 2001.
(60) Provisional application No. 60/189,504, filed on Mar. 15, 2000.

(51) Int. Cl. B32B 35/00

(52) U.S. Cl. 156/98; 156/137; 156/304.5

(57) ABSTRACT

The invention is a method of joining two belt ends together, either laterally or longitudinally, and the resulting belt. The two ends can be of two different belts being joined, a short section added to replace a damaged section of a belt, or two ends of the same belt. Moreover, the belt or belts can be damaged or intentionally cut in preparation of their joining. The belt ends are stripped of their rubber or elastomeric coating that covers the cord core, and the ends can be fashioned in any shape such that one belt end complements the other end when abutted. The ends are joined and a new rubber layer is then bonded to the belt above and below the cord core.

### CROSS-REFERENCES

This application claims priority to non-provisional patent application serial No. 09/809,601, filed Mar. 15, 2001 which claims priority to provisional patent application No. 60/189,504, filed Mar. 15, 2000, both of which are incorporated herein in their entirety.

### FIELD OF INVENTION

This invention relates generally to the art of joining ends of a belt or belts together. More specifically, the invention relates to joining the ends of power or conveyor having a cord core and covered with rubber or elastomeric material. The invention also relates to the belt that results from this method.

### BRIEF DESCRIPTION OF THE DRAWINGS

FIG. 1A is a side view of a belt to be joined with blunt ends.

FIG. 1B is a top view of the belt of FIG. 1A, with blunt ends joined together by sewing.

FIG. 1C is a side view of the belt of FIG. 1B, with new rubber layers ready to be placed over the joined area.

FIG. 1D is a perspective side view of the resulting joined and bonded belt.

FIG. 2A is a side view of a belt to be joined with stepped ends.

FIG. 2B is a top view of the belt of FIG. 2A, with stepped ends joined together by sewing.

FIG. 2C is a side view of the belt of FIG. 2B, with new rubber layers ready to be placed over the joined area.

FIG. 2D is a perspective side view of the resulting joined and bonded belt.

### DESCRIPTION OF EMBODIMENTS OF THE INVENTION

The invention is a method of joining two ends of a belt together. For the purposes of describing the invention, the joining of two ends of a conveyor belt will be discussed, although one skilled in the art will recognize that this invention can be applied to any belt that has a cord core and a rubber or elastomeric coating. Example types of conveyor belts to which this method applies are single-ply belts, 2-ply belts, 3-ply belts, 4-ply belts, US Flex 11 (660 P.I.W.) belts, and light duty belting. These and similar belts are well-known to those in the art. Some examples of synthetic rubbers, but not by way of limitation, are styrenebutadiene rubber, viapreme, polybutadiene, and urethane. Moreover, the method may be applied to any type of rubberized layer.

Furthermore, while reference may be made to repairing a damaged belt, it should be understood that the two ends to be joined could also be of two different belts being joined together to create a longer belt, a short section added to replace a damaged section of a belt (called a “saddle”), or two ends of the same belt being joined (e.g., for shortening a belt). Moreover, the belt or belts can be damaged or intentionally cut in preparation of their joining. In addition, if the belt is damaged, the tear or rip can be either longitudinal (i.e., along the length of the belt) or lateral (along the width of the belt). It should also be understood that the tear or rip need not run the entire length or width of the belt. The method is equally applicable to a damaged belt section that runs only partly across the width of the belt or along the length of the belt.

While the method and resulting belt are susceptible to various alternative forms and modifications, specific embodiments will be shown by way of example in the drawings and will be described in detail herein. However, it should be understood that the invention is not intended to be limited to the particular forms disclosed. Rather, the invention is to cover all modifications, equivalents, and alternatives following within the spirit and scope of the invention as defined by the claims.

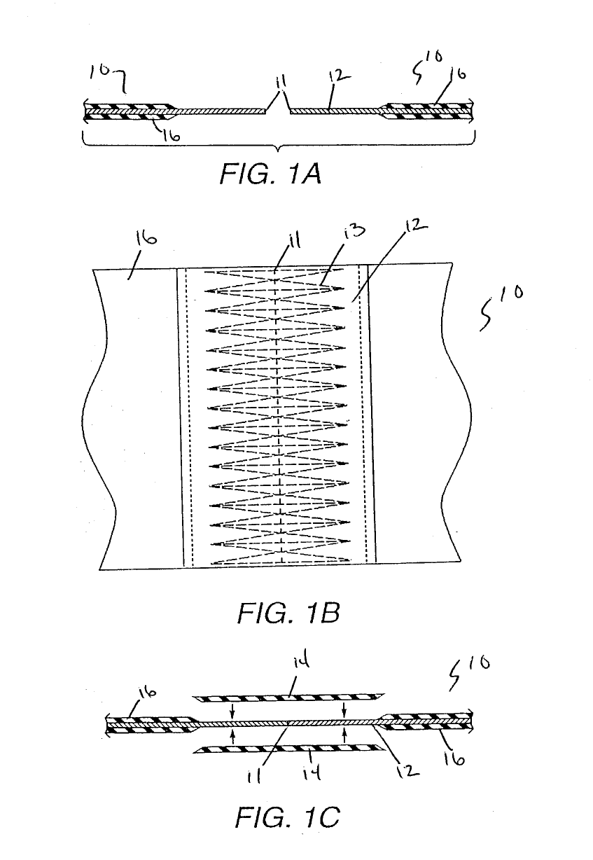

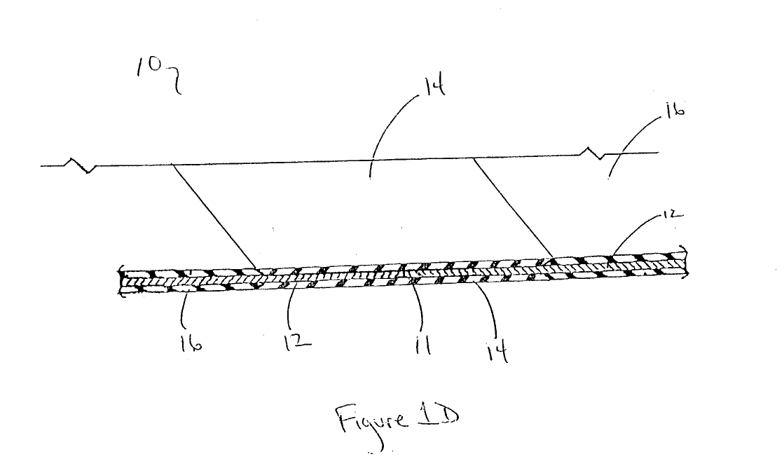

With reference to the drawings, the reader should understand that like reference numerals in different drawings refer to the like elements of the invention. FIG. 1A shows a side view of belt 10, with blunt ends 11, to be joined. Belt 10 has been prepared by removing any frayed material from ends 11 of belt 10 and then stripping rubber coating 16 from the damaged area down to cord core 12. The length of the exposed cord core 12 will depend on the strength of the belt to be spliced as well as the desired splice length. One of ordinary skill in the art will recognize that any method of stripping well-known in the art can be used, including, but not limited to peeling and chemical. The various stripping methods commonly leave behind a small skim of rubber on the cord core or pieces of rubber imbedded in or attached to the cord core. However, care should be taken in the stripping process to maintain the full integrity of cord core 12. One of ordinary skill in the art will realize that any method of stripping and preparing the belt ends that will allow the ends to be joined together is suitable for use with this method. In the embodiment shown in FIG. 1A, the ends of belt 10 that are to be abutted are cut to blunt ends 11. The blunt ends 11 are then joined, resulting in the belt shown in FIG. 1B.

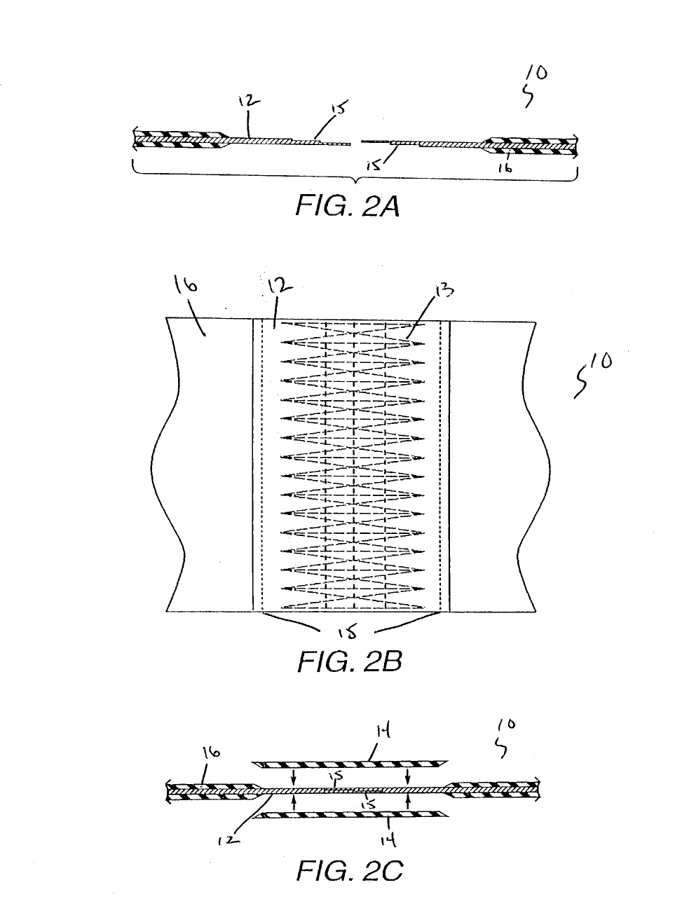

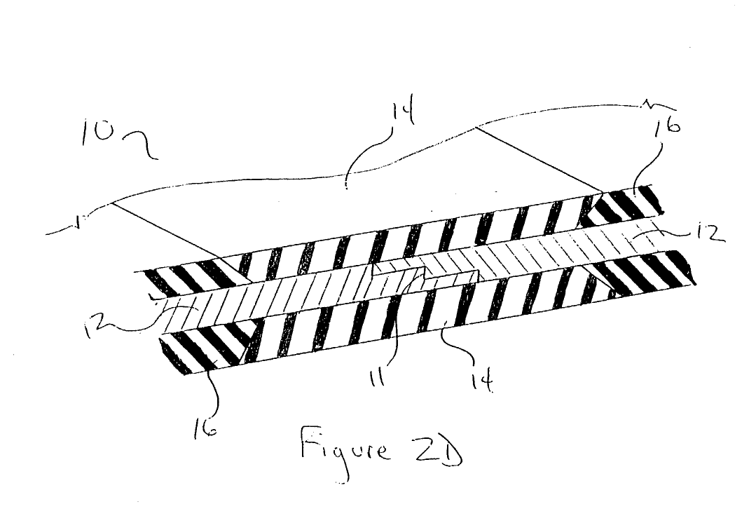

Although the figures show ends 11 (in FIGS. 1A through 1D) and 15 (in FIGS. 2A through 2D, infra) being cut at generally a right angle relative to the length of belt 10 (i.e., a squared-off shape), ends 11, 15 could also be cut at other angles (45°, for instance), resulting in a wedge shape, as viewed from above belt 10. Each end 11, 15, therefore, has both an acute and an obtuse angle. Ends 11, 15 could also be cut in a “V-shape,” a semi-circle, or any other shape known to those of ordinary skill in the art.

One of ordinary skill in the art will appreciate that any method of joining the two cord cores 12 can be used. One example is by sewing ends 11 together, either by hand or by utilizing appropriate machines. Examples include a pneumatic or mechanically-operated machine and a computer-controlled multi-axis computer numerically controlled (CNC) machine such as can be purchased from Ontario Sewing Automation™ using 250 pound test nylon (a linear polyamide). Generally, “long-arm” types of machines, as can be purchased from any sewing machine manufacturer will work; for example, Consew™ and Pfaff™. Further examples of threads or fibers that can be used for sewing the ends together are other polymer fibers such as Kevlar™ (a polyaromatic amide) and Spectra™ (an ultra-high molecular weight polyethylene fiber) brand threads.

Furthermore, since the joint will ultimately be covered by rubber layer 14, splicing clips or metal fasteners can be used to join the ends together. That is, even if they protrude from cord core 12, that protrusion will be covered by the added rubber layer 14 and are therefore not at risk of catching while the belt is in use.

It should be apparent to one skilled in the art that if ends 11 are sewed together as shown in the figures, many different sewing patterns can be used. For example, square, figure 8, or circle patterns may be used. In the embodiment shown in FIG. 1B, a diamond-shaped sewing pattern 13 is used.

In another embodiment of the invention in which ends 11 are joined by sewing, the portion of belt 10 that is sewn includes not only the portion of belt 10 closest to the mated area, but also most of the exposed cord core 12 of belt 10. The mated ends 11 of belt 10 are the weakest sections of belt 10. Sewing over the exposed cord core 12 of belt 10 helps ensure that ends 11 remain joined since the area sewed includes stronger portions of belt 10 that will resist the forces pulling ends 11 of belt 10 apart. Typically approximately two (2) inches in each direction from abutted ends 11 is sufficient to provide sufficient root strength to the joining. Less than that amount could result in a weak joint; more than that would amount in a waste of material and unnecessary time spent forming the joint. However, one of ordinary skill in the art will realize that the exact width of sewing pattern 13 will depend on the material of cord core 12 and on the material chosen for the thread used.

Once ends 11 of belt 10 are joined, a new rubber layer 14 is cut to the same length and width as the exposed cord core 12 on the two ends 11 of belt 10. Rubber layer 14 is then placed over the joined portion on both sides of belt 10, as shown in FIG. 1C. As seen in FIG. 1C, the shape of rubber layer 14 is beveled into a wedge-like shape. This shape prevents cracking at the seam between rubber layer 14 and rubber coating 16. However, one of ordinary skill in the art will realize that other shapes of rubber layer 14 can be used. The new rubber layer 14 is then bonded to the exposed cord core 12 and rubber coating 16. That is, the sides of the new rubber layer 14 added to the top of the mated cord core 12 bonds with sides of both rubber coatings 16, and the bottom of new rubber layer 14 bonds to the top of cord core 12. Similarly, rubber layer 14 added to the bottom of cord core 12 bonds to both rubber coatings 16 as well as to the bottom of cord core 12.

FIG. 1D shows a top perspective view of the resulting joined and bonded belt 10 with mated blunt ends 11 being joined by sewing. The repaired portion of belt 10 should be the same thickness as the remainder of belt 10 so as not to interfere with the proper use of belt 10.

One of ordinary skill in the art will recognize that the manner in which rubber layer 14 is bonded to cored core 12 and rubber coating 16 can be accomplished in a number of ways. Two such examples are hot vulcanization and cold vulcanization. In cold vulcanization, rubber layer 14 and some of the surrounding belt rubber and cord core is treated with a chemical cement and hardener, a pourable urethane, or a pourable putty. An examples of the cement/hardener mixture is Tip Top™ CRV 5 in combination with Tip Top™ SC 2000 cement and RF Hardener. Examples of pourable urethanes include Chem-Calk® from Bostik Findley, Inc.™, Vulkem 245™ from Tremco™, and products manufactured by Linatex™. Examples of pourable putties include Rema™ Goo™, Chemlock 220™, and Nylabond™, as well as products manufactured by Valspar™ and Dolphin™. All of these products, as well as products like them, are well-known to those of ordinary skill in the art. The cement/hardener mixture and the pourable urethanes and putties impregnate rubber layer 14 and mix rubber layer 14 with the surrounding rubber coating 16 and cord core 12 so that a seamless joining is affected. The cement/hardener mixture and the pourable urethanes and putties must typically be applied more than one time, and allowed to dry completely between coats.

In hot vulcanization, a primer and cement combination, a pourable urethane, or a pourable putty is used to facilitate the bonding of rubber layer 14 to cord core 15 and rubber coating 16. Heat and pressure are then applied to the area. The heat melts the rubber and allows rubber layer 14 to mix with the surrounding rubber coating 16 and cord core 15. The mixed rubber is allowed to cool and a seamless joining is affected. Two examples of the primer and cement combination are Scandura™ primer 1940 used in conjunction with P800 cement and Goodyear™ Chemlock™ primer and 920 cement. Examples of pourable urethanes and pourable putties are the same as provided supra with respect to cold vulcanization. In one embodiment of the hot vulcanizing step, a vulcanizing press is use.

FIG. 2A is a side view of a belt to be joined, similar to that shown in FIG. 1A, but in which the ends of belt 10 have been cut into steps. In this embodiment, as in FIG. 1A, the frayed material has already been removed from stepped ends 15 of belt 10. Stepped ends 15 are cut so that when placed together, they overlap, as seen in FIG. 2C. This results in a plurality of surfaces where stepped ends 15 abut, rather than just one, as in the case of blunt ends 11 as shown in FIGS. 1A and 1C. Stepped ends 15 are then joined together. As discussed with respect to FIGS. 1A and 1B, in one embodiment of the invention, stepped ends 15 are joined by sewing them together. In the embodiment shown in FIG. 2B, stepped ends 15 are sewn together with a diamond-shaped sewing pattern 13, resulting in belt 10 shown in FIG. 2B.

It should be apparent to one skilled in the art that, as in the embodiment shown and described in FIGS. 1A through 1D, many different sewing patterns can be used to join stepped ends 15 together. For example, square, figure 8, or circle patterns may also be used. In one embodiment, stepped ends 15 are joined by sewing. Again as seen in the embodiment shown in FIG. 2B, the portion of belt 10 that is sewn spans at least the entire area of stepped ends 15 into cord core 12 of exposed belt 10. Using stepped ends 15 eliminates peeling and adds strength to the splice via power transmission through the sewing thread. Those of ordinary skill in the art will recognize that different stitch lengths and threading material may be required for different belt 10 widths, thicknesses, and strengths.

Once stepped ends 15 of belt 10 are joined together, two new rubber layers 14 are cut to the same length and width as the exposed area of belt 10. A new rubber layer 14 is then placed over the joined portion over both sides of belt 10, as shown in FIG. 2C. The area of belt 10 including stepped ends 15, cord core 12, rubber layer 14, and sewing pattern 13 is then bonded, through techniques as previously discussed. The resultant repaired portion of belt 10 is the same thickness as the remainder of belt 10. FIG. 2D demonstrates the joined by sewing and bonded belt 10 with mated stepped ends 15 as seen in a side perspective view.

It will be apparent to one of ordinary skill in the art that many variations of this invention can be made without departing from the spirit of the invention as claimed, including, but not limited to, the means by which the rubber or rubber-like coating is stripped, the shape of the belt ends to be joined, the method chosen to join the ends, and the bonding process.

What is claimed is:

1. A method of joining a first belt end to a second belt end, wherein said first belt end and said second belt end are each comprised of a cord core with an upper surface and a lower surface, a first coating disposed on said upper surface, and a second coating disposed on said lower surface, comprising the following steps:
stripping a portion of said first coating and a portion of said second coating from said first belt end and said second belt end, exposing a portion of said upper surface and a portion of said lower surface of each of said first belt end and said second belt end;
abutting said first belt end to said second belt end;
joining said first belt end to said second belt end;
applying a first rubber layer over said exposed portions of said upper surface of said first belt end and said upper surface of said second belt end;
applying a second rubber layer over said exposed portions of said lower surface of said first belt end and said lower surface of said second belt end; and
bonding said first rubber layer and said second rubber layer to said first belt end and said second belt end.

2. The method of claim 1, wherein said first belt end and said second belt end are damaged.

3. The method of claim 1, wherein said stripping step further includes removing any frayed material from said first belt end and said second belt end.

4. The method of claim 1, wherein said first belt end and said second belt end are each blunt.

5. The method of claim 1, wherein said first belt end and said second belt end are each stepped.

6. The method of claim 1, wherein said first belt end and said second belt end are each cut in a shape selected from a group comprising a squared-off shape, a wedge shape, a “V-shape,” and a generally semicircular shape.

7. The method of claim 1, wherein said first coating and said second coating are made of a rubber or an elastomeric material.

8. The method of claim 1, wherein said joining step is by sewing said first belt end to said second belt end with a sewing pattern.

9. The method of claim 8, wherein said sewing pattern is selected from a group comprising a circle pattern, a square pattern, a figure 8 pattern, and a diamond-shaped pattern.

10. The method of claim 8, wherein said sewing pattern uses a material selected from a group of fibers comprised of polymer fibers.

11. The method of claim 1, wherein said joining step is performed using a device selected from a group comprised of one or more splicing clips and one or more metal fasteners.

12. The method of claim 1, wherein said first belt end is of a first belt and said second belt end is of a second belt.

13. The method of claim 1, wherein said first belt end and said second belt end are both of a same belt.

14. The method of claim 1, wherein said bonding step is performed using a technique selected from a group comprised of cold vulcanization and hot vulcanization.

15. The method of claim 1, wherein said first rubber layer and said second rubber layer are beveled.

16. A method of splicing a first end of a first belt to a second end of a second belt, wherein said first belt and said second belt are each comprised of a cord core with an upper surface and a lower surface, a first coating disposed on said upper surface, and a second coating disposed on said lower surface, comprising the following steps:
stripping said first coating and said second coating from an area surrounding each of said first end and said second end;
abutting said first end to said second end;
joining said first end to said second end;
applying a first rubber layer over said area surrounding each of said first end and said second end;
applying a second layer of rubber under said area surrounding each of said first end and said second end; and
bonding said area.

17. The method of claim 16, wherein said first end of said first belt and said second end of said second belt are damaged.

18. The method of claim 17, wherein said preparing step further includes removing any frayed material from said first end and said second end.

19. The method of claim 16, wherein each of said first end of said first belt and said second end of said second belt are blunt.

20. The method of claim 16, wherein each of said first end of said first belt and said second end of said second belt are stepped.

21. The method of claim 16, wherein said first end of said first belt and said second end of said second belt are each cut in a shape selected from a group comprising a squared-off shape, a wedge shape, a “V-shape,” and a generally semicircular shape.

22. The method of claim 16, wherein said first coating and said second coating are made of a rubber or an elastomeric material.

23. The method of claim 16, wherein said joining step is performed using a device selected from a group comprising one or more splicing clips and one or more metal fasteners.

24. The method of claim 16, wherein said joining step is by sewing said first end of said first belt to said second end of said second belt using a sewing pattern.

25. The method of claim 24, wherein said sewing pattern is selected from a group comprising a circle pattern, a square pattern, a figure 8 pattern, and a diamond-shaped pattern.

26. The method of claim 24, wherein said sewing pattern uses a material selected from a group of fibers comprising polymer fibers.

27. The method of claim 16, wherein said vulcanizing step is selected from a group comprising cold vulcanization and hot vulcanization.

28. The method of claim 16, wherein said first rubber layer and said second rubber layer are beveled.

29. A method of splicing a first end of a belt to a second end of said belt, wherein said belt is comprised of a cord core with an upper surface and a lower surface, a first coating disposed on said upper surface, and a second coating disposed on said lower surface, comprising the following steps:
stripping said first coating and said second coating from an area surrounding each of said first end and said second end;
abutting said first end to said second end;
joining said first end to said second end;
applying a first rubber layer over said area surrounding each of said first end and said second end;
applying a second layer of rubber under said area surrounding each of said first end and said second end; and
bonding said area.

30. The method of claim 29, wherein said first end and said second are damaged.

31. The method of claim 30, wherein said preparing step further includes removing any frayed material from said first end and said second end.

32. The method of claim 29, wherein each of said first end and said second end are blunt.

33. The method of claim 29, wherein each of said first end and said second end are stepped.

34. The method of claim 29, wherein said first end and said second end are cut in a shape selected from a group comprising a squared-off shape, a wedge shape, a “V-shape,” and a generally semicircular shape.

35. The method of claim 29, wherein said first coating and said second coating are made of a rubber or an elastomeric material.

36. The method of claim 29, wherein said joining step is performed using a device selected from a group comprising one or more splicing clips and one or more metal fasteners.

37. The method of claim 29, wherein said joining step is by sewing said first end of said belt to said second end with a sewing pattern.

38. The method of claim 37, wherein said sewing pattern is selected from a group comprising a circle pattern, a square pattern, a figure 8 pattern, and a diamond-shaped pattern.

39. The method of claim 37, wherein said sewing pattern uses a material selected from a group comprising polymer fibers.

40. The method of claim 29, wherein said bonding step is performed using a technique selected from a group comprised of cold vulcanization and hot vulcanization.

41. The method of claim 29, wherein said first rubber layer and said second rubber layer are beveled.

42. A belt comprised of a cord core with an upper surface and a lower surface, a first coating disposed on said upper surface, and a second coating disposed on said lower surface, produced by a method comprising the steps of:
stripping a portion of said first coating and a portion of said second coating from a first belt end and a second belt end, exposing a portion of said upper surface and said lower surface of each of said first belt end and said second belt end;
abutting said first belt end to said second belt end;
joining said first belt end to said second belt end;
applying a first rubber layer over said exposed portions of said upper surface of said first belt end and said upper surface of said second belt end;
applying a second rubber layer under said exposed portions of said lower surface of said first belt end and said lower surface of said second belt end; and
bonding said first rubber layer and said second rubber layer to said first belt end and said second belt end.

43. The belt of claim 42, wherein said first belt end and said second belt end are damaged.

44. The belt of claim 42, wherein said stripping step further includes removing any frayed material from said first belt end and said second belt end.

45. The belt of claim 42, wherein said first belt end and said second belt end are each blunt.

46. The belt of claim 42, wherein said first belt end and said second belt end are each stepped.

47. The belt of claim 42, wherein said first belt end and said second belt end are each cut into a shape selected from a group comprising a squared-off shape, a wedge shape, a “V-shape,” and a generally semicircular shape.

48. The belt of claim 42, wherein said first coating and said second coating are made of a rubber or an elastomeric material.

49. The belt of claim 42, wherein said joining step is by sewing said first belt end to said second belt end with a sewing pattern.

50. The belt of claim 49, wherein said sewing pattern is selected from a group comprising a circle pattern, a square pattern, a figure 8 pattern, and a diamond-shaped pattern.

51. The belt of claim 49, wherein said sewing pattern uses a material selected from a group of fibers comprising polymer fibers.

52. The belt of claim 42, wherein said joining step is performed using a device selected from a group comprised of one or more splicing clips and one or more metal fasteners.

53. The belt of claim 42, wherein said first belt end is of a first belt and said second belt end is of a second belt.

54. The belt of claim 42, wherein said first belt end and said second belt end are both of a same belt.

55. The belt of claim 42, wherein said bonding step is performed using a technique selected from a group comprised of cold vulcanization and hot vulcanization.

56. The belt of claim 42, wherein said first rubber layer and said second rubber layer are beveled.

57. A belt comprised of a cord core with an upper surface and a lower surface, a first coating disposed on said upper surface, and a second coating disposed on said lower surface, produced by a method comprising the steps of:
stripping a portion of said first coating and a portion of said second coating from a first belt end and a second belt end, exposing a portion of said upper surface and said lower surface of each of said first belt end and said second belt end;
abutting said first belt end to said second belt end;
sewing said first belt end to said second belt end using a sewing pattern;
applying a first rubber layer over said exposed portions of said upper surface of said first belt end and said upper surface of said second belt end;
applying a second rubber layer over said exposed portions of said lower surface of said first belt end and said lower surface of said second belt end; and
bonding said first rubber layer and said second rubber layer to said first belt end and said second belt end.

58. The belt of claim 57, wherein said first belt end and said second belt end are damaged.

59. The belt of claim 58, wherein said stripping step further includes removing any frayed material from said first belt end and said second belt end.

60. The belt of claim 57, wherein said first belt end and said second belt end are each blunt.

61. The belt of claim 57, wherein said first belt end and said second belt end are each stepped.

62. The belt of claim 57, wherein said first belt end and said second belt end are cut in a shape selected from a group comprising a squared-off shape, a wedge shape, a “V-shape,” and a generally semicircular shape.

63. The belt of claim 57, wherein said first coating and said second coating are made of a rubber or an elastomeric material.

64. The belt of claim 57, wherein said sewing pattern is selected from a group comprising a circle pattern, a square pattern, a figure 8 pattern, and a diamond-shaped pattern.

65. The belt of claim 57, wherein said sewing pattern uses a material selected form a group comprising polymer fibers.

66. The belt of claim 57, wherein said first belt end is of a first belt and said second belt end is of a second belt.

67. The belt of claim 57, wherein said first belt end and said second belt end are both of a same belt.

68. The belt of claim 57, wherein said bonding step is performed using a technique selected from a group comprised of cold vulcanization and hot vulcanization.

69. The belt of claim 57, wherein said first rubber layer and said second rubber layer are beveled.
